(19) United States
(12) Patent Application Publication
(10) Pub. No.: US 2012/0063794 A1
(43) Pub. Date: Mar. 15, 2012

(54) IMAGE FORMING APPARATUS, GAP CONTROL METHOD

(75) Inventors: Masashi Takahashi, Kanagawa-ken (JP); Takeshi Watanabe, Kanagawa-ken (JP); Daisuke Yamashita, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/215,448

(22) Filed: Aug. 23, 2011

Related U.S. Application Data
(60) Provisional application No. 61/381,126, filed on Sep. 9, 2010.

(51) Int. Cl. G03G 15/00; G03G 15/02

(52) U.S. Cl. 399/44; 399/115

(57) ABSTRACT

An image forming apparatus according to the embodiments includes a photoconductor, a charging unit which charges the photoconductor and is disposed to face the photoconductor in a non-contact manner, a positioning portion which changes a gap interposed between the photoconductor and the charging unit, on the basis of at least the temperature.

### CROSS-REFERENCE TO RELATED APPLICATIONS

This application is based upon and claims the benefit of priority from: U.S. provisional application 61/381126, filed on Sep. 9, 2010; the entire contents all of which are incorporated herein by reference.

### FIELD

Embodiments described herein generally relate to a technology for controlling a gap between a photoconductor and a charging unit of an image forming apparatus.

### BACKGROUND

Recently, a technology of an image forming apparatus is widely known in which a minute gap (hereinafter, referred to as a gap) is provided between a photoconductive drum and a charging roller, and the photoconductive drum is charged in a non-contact manner. In the related art, a non-contact type charging roller is fixed and arranged to the photoconductive drum with a predetermined gap.

However, when the non-contact type charging roller is fixed, there is a problem in that more stable and uniform charging may not be performed corresponding to environmental fluctuations such as in temperature or humidity.

### DESCRIPTION OF THE DRAWINGS

FIG. 1 is a schematic diagram showing a configuration example of an image forming apparatus.

FIG. 2A is a table showing a result of a margin determination for each gap length in a low temperature and low humidity environment.

FIG. 2B is a table showing the results of a margin determination for each gap length in a high temperature and high humidity environment and a determination result of bleeding out.

FIGS. 3A and 3B are diagrams showing an example of arranging a charging roller, a photoconductive drum, and a positioning member in a first embodiment.

FIGS. 4A and 4B are diagrams showing an example of arranging a charging roller, a photoconductive drum, and a positioning member in a second embodiment.

FIG. 5 is a diagram showing a configuration example of a third embodiment.

FIG. 6 is a flowchart showing an operation example of the third embodiment.

FIG. 7 is a diagram describing an example in which an output level is derived from the humidity and temperature in the third embodiment.

### DETAILED DESCRIPTION

An image forming apparatus according to the embodiments includes a photoconductor, a charging unit which charges the photoconductor and is disposed to face the photoconductor in a non-contact manner, and a positioning portion which changes a gap between the photoconductor and the charging unit based on at least the temperature.

Here, before making a detailed description of the embodiment, the relationship of the gap between a photoconductive drum and a charging roller, and temperature and humidity will be described. In a low temperature and low humidity environment, the margin (an area where a uniform discharging is made) between the photoconductive drum and the charging roller is narrowed, so that the gap is desired to be narrowed. On the other hand, in a high temperature and high humidity environment, the gap margin is sufficient in a view point of charging property, however, due to a problem of bleeding out (contamination of the photoconductive drum due to oozing out of additives from a roller), conversely, it is desirable to widen the gap so that the charging roller (exactly, the additives oozing out on the surface of the charging roller) does not come into close contact with the photoconductive drum.

In this manner, it is preferable that the gap between the charging roller and the photoconductive drum be precisely adjusted according to the environment in order to perform more stable charging, rather than be maintained at a constant interval.

The non-contact type charging roller of each embodiment, which will be described below, can perform more stable and uniform discharging by changing the gap according to environmental fluctuations, such as the temperature and humidity.

In a first and second embodiments, since a material of the gap positioning member is a material which deforms according to the environmental fluctuation, an example in which the adjustment of the gap is performed by selecting the optimal value of the coefficient of thermal expansion thereof, will be described. In addition, in a third embodiment, an example in which the temperature and humidity are detected by sensors and the gap is controlled to be mechanically changed on the basis of the detected results, will be described.

Hereinafter, each embodiment will be described.

### First embodiment

The image forming apparatus including the non-contact type charging roller of this embodiment may be a monochrome image forming apparatus or a four rotation-type color image forming apparatus in which a plurality of developing devices is arranged around the photoconductor, and may be a tandem-type color image forming apparatus in which a plurality of photoconductors is arranged.

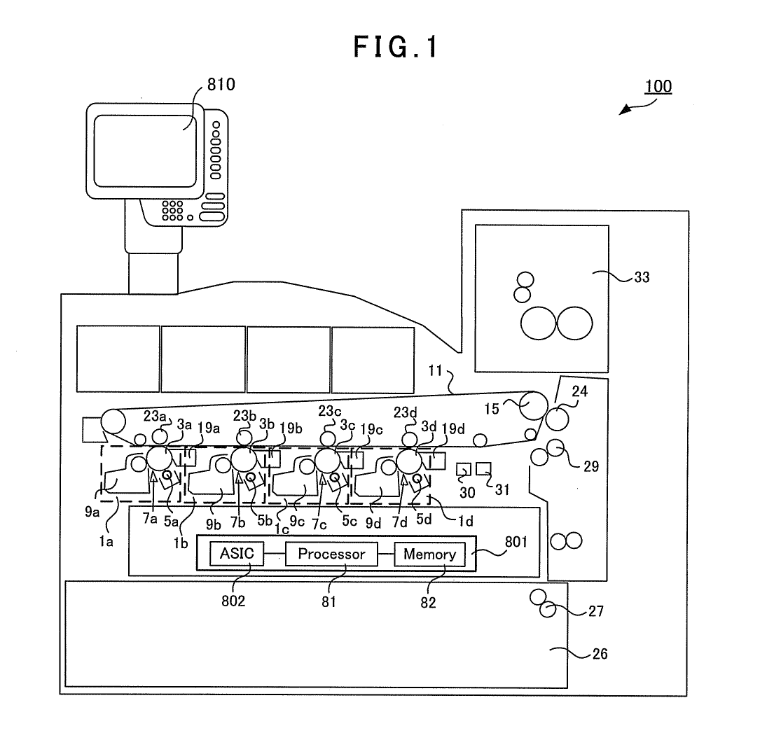

As an example, a schematic view of a tandem-type color image forming apparatus 100 is shown in FIG. 1.

Hereinafter, an image forming process will be described.

In FIG. 1, process units 1a, 1b, 1c, and 1d that are image forming units, are provided. Each process unit has photoconductive drums 3a, 3b, 3c, and 3d that are image carriers, and images formed using developer are formed in these photoconductors.

A process unit la will be described.

In FIG. 1, the photoconductive drum 3a is a cylindrical shape and is provided in a rotatable manner. In a periphery of the photoconductive drum 3a, followings are arranged along the rotation direction. First, a charging roller 5a, which is a cylindrical charging unit is provided to face the surface of the photoconductive drum 3a. The charging roller 5a uniformly charges the photoconductive drum 3a to be negative. On the downstream side of the charging roller 5a, an exposure device 7a which exposes the charged photoconductive drum 3a and forms an electro-static latent image is provided. In addition, on the downstream side of the exposure device 7a, a developing device 9a which accommodates a yellow developer and reversely develops the electro-static latent image which is formed using the exposure device 7a using the developer, is provided. An intermediate transfer belt 11 which is a medium in which images are formed is provided to be in close contact with the photoconductive drum 3a.

A cleaner 19a is provided on the downstream side of the contact position between the photoconductive drum 3a and the belt 11. After transferring, the cleaner 19a neutralizes the surface charge of the photoconductive drum 3a by uniformly irradiating with light, and removes and accommodates the remaining toner on the photoconductor. In this manner, one cycle of image formation is finished, and in the subsequent image forming process, the charging roller 5a resumes the uniform charging of the photoconductive drum 3a which is uncharged.

The process unit la is configured by the above described photoconductive drum 3a, the charging roller 5a, the exposure device 7a, the developing device 9a, and the cleaner 19a.

The belt 11 has substantially the same length (width) as that of the photoconductive drum 3a in a direction orthogonal to the transporting direction (a depth direction in figures). The belt 11 has an endless shape (seamless) and is carried on a driving roller 15 which rotates the belt 11 at a predetermined speed, and a number of driven rollers.

The belt 11 is formed of polyimide having a thickness of 100 μm, in which carbon is uniformly dispersed. The belt 11 has an electric resistance of 10⁹ Ωcm and exhibits semi-conductive property. As a material of the belt 11, it is preferable to adopt materials showing a semi-conductive property having a volume resistance value of 10⁸ Ωcm to 10¹¹ Ωcm. For example, in addition to the polyimide in which carbon is dispersed, materials may be preferably used in which conductive particles, such as carbon, are dispersed in polyethylene-terephthalate, polycarbonate, polytetra-fluoroethylene, polyvinilidene-fluoride, or the like. A polymer film in which electric resistivity is adjusted by the composition adjustment may be used. Further, a material in which an ion conductive material is mixed into such a polymer film, or rubber materials such as a silicon rubber, or urethane rubber, which have relatively low electric resistivity, may be used without using conductive particles.

On the belt 11, in addition to the process unit 1a, the process units 1b, 1c, and 1d are arranged between the driving roller 15 and a secondary transfer opposing roller 24, along the transporting direction of the belt 11. Any of the process units 1b, 1c and 1d has the same configuration as that of the process unit 1a. That is, at the approximate center of each of the process units, the photoconductive drums 3b, 3c and 3d are provided. In the periphery of each of the photoconductive drums, charging rollers 5b, 5c and 5d are respectively provided. Exposure devices 7b, 7c, and 7d are provided on the downstream side of the charging roller. They have the same configuration as that of the process unit 1a by being provided with developing devices 9b, 9c and 9d, cleaners 19b, 19c, and 19d on the downstream side of the exposure device. The difference is the developer which is contained in the developing device. The developing device 19b contains a magenta developer, the developing device 19c contains a cyan developer, and the developing device 19d contains a black developer.

The belt 11 is sequentially coming into close contact with the respective photoconductive drums.

In the vicinity of the contact position between the belt 11 and the respective photoconductive drums, transfer members 23a, 23b, 23c, and 23d are correspondingly provided to the respective photoconductive drums as the transfer unit. That is, the transfer member 23 is provided to the belt 11 in a rear contacting manner above the corresponding photoconductive drum and faces the process unit via the belt 11.

The transfer member 23a is connected to a positive DC power 25a (not shown) which is a voltage application unit. Similarly, the transfer members 23b, 23c, and 23d are respectively connected to the respective DC powers 25b, 25c, and 25d (not shown).

Meanwhile, in FIG. 1, a paper feeding cassette 26 which contains sheets of paper is provided at the bottom side of the image forming unit. In the image forming apparatus 100, a pickup roller 27 which picks up sheet of paper one by one from the paper feeding cassette 26 is provided. A pair of resist rollers 29 is provided in the vicinity of the secondary transfer opposing roller 24 in a rotating manner. The pair of resist rollers 29 feed sheet of paper to a secondary transfer unit in which the secondary transfer opposing roller 24 faces the driving roller 15 with the belt interposed therebetween.

In addition, in FIG. 1, there is provided a fixer 33 which fixes the developer on the sheet of paper and an in-barrel paper discharging portion where the sheet of paper fixed using the fixer is discharged, on the front right side of the belt 11.

A color image forming operation of the image forming apparatus 100, which is configured as described above, will be described.

When an instruction for starting the image forming operation is made, the photoconductive drum 3a starts rotation by receiving a driving power from a driving mechanism (not shown). The charging roller 5a uniformly charges the photoconductive drum 3a at about −600 V. The exposure device 7a forms an electro-static latent image in the photoconductive drum 3a which is uniformly charged by the charging roller 5a, by irradiating with light which corresponds to the image to be recorded. The developing device 9a contains a developer (two-component developer of yellow (Y) toner+ferrite carrier), and provides a bias value of −380V to a developing sleeve (not shown) using a developing bias source (not shown) to form a developing electric field between the developing device 9a and the photoconductive drum 3a. The Y toner which is negatively charged, shows a reversal development which attaches to a potential area of an imaging unit of the electrostatic latent image of the photoconductive drum 3a.

Subsequently, the developing device 9b develops the electro-static latent image using the magenta developer and forms a magenta toner (M toner) image on the photoconductive drum 3b. At this time, the M toner has the same volume average particle diameter of 7 μm as that of the Y toner and is negatively charged due to ferrite magnetic carrier particles (not shown) having a volume average particle diameter of about 50 μm and a frictional electrification. An average charge amount is about −30 μC/g. A value of the developing bias is about −380V, similarly to the developing device 9a and is applied to the developing sleeve (the structure of the developing device is the same as that of the developing device 9a) using the bias source (not shown). In the imaging unit, the developing electric field moves from the surface of the photoconductive drum 3b toward the developing sleeve and the negatively charged M toner is attached to a portion which has a latent image potential.

In a transfer region formed using the photoconductive drum 3a, the belt 11, and the transfer member 23a, a bias voltage of about +1000 V is applied to the transfer member 23a. A transfer electric field is formed between the transfer member 23a and the photoconductive drum 3a, and the yellow toner image on the photoconductive drum 3a is transferred to the belt 11 according to the transfer electric field.

A part of the transfer member 23a will be described in more detail.

The transfer member 23a is a conductive polyurethane foam roller which has conductivity by dispersing carbon. A roller having an outer diameter of φ18 mm is formed around a cored bar having a diameter of φ10 mm. The electric resistance between the cored bar and the surface of the roller is about 10e6Ω. The constant voltage DC power 25a is connected to the cored bar.

A power feeding device in the transfer member 23a is not limited to the roller and it may be a conductive brush, a conductive rubber plate, a conductive sheet, or the like. The conductive sheet is a rubber material in which carbon is dispersed, or a resin film, and may be a rubber material such as silicon rubber, urethane rubber, or EPDM, and may be a resin material such as polycarbonate. It is desirable for them to have a volume resistance value of 10e5 to 10e7 Ωcm.

A spring, as an urging unit, is provided at both ends of the roller shaft, and the transfer member 23a is urged to the belt 11 using the spring, so as to elastically come into contact with the belt 11 in the vertical direction. The magnitude of the urging force due to the spring, which is arranged in each transfer member, is set to 600 gft. Here, the urging force indicates the total urging force of each spring disposed at both ends of the roller shaft.

The configuration of the transfer members 23b, 23c, and 23d is the same as that of the transfer member 23a, and the configuration of elastically coming into close contact with the belt 11, is the same as that of the transfer member 23a. Accordingly, descriptions of the configuration of the transfer member 23b, 23c, and 23d will be omitted.

The image on the belt 11, which is a transferred Y (yellow) toner image is transported to the magenta transfer region in the transfer region. In the transfer region, a bias voltage of about +1200V is applied to the transfer member 23b from the DC power, thereby transferring a magenta toner image by overlapping with the Y toner image. A bias voltage of about +1400 V is applied to the transfer member 23c in the cyan transfer region, and a voltage of about +1600 V is applied to the transfer member 23d in the black transfer region, thereby a cyan developer image and a black developer image is sequentially transferred in an overlapping manner on the developer image which is already transferred. Meanwhile, the pick up roller 27 extracts a sheet of paper from the paper feeding cassette 26 and the pair of resist rollers 29 supplies the sheet P to the secondary transfer unit.

In the secondary transfer unit, a predetermined bias is applied to the secondary transfer opposing roller, and a transfer electric field is formed between the secondary transfer unit and the secondary transfer opposing roller with the belt interposed therebetween. Further, a multi-color toner image on the belt 11 is integrally transferred to the sheet P. In this manner, the respective colors of developer images are fixed onto the sheet P using the fixer 33, thereby forming a color image. The sheet P on which fixing is finished, is discharged to the in-barrel paper discharging portion.

The image forming apparatus 100 includes a control board 801, and the control board 801 includes a processor 81 which is an arithmetic processing unit, (for example, a CPU (Central Processing Unit), an MPU (Micro Processing Unit)), and a memory 82 including an ASIC (Application Specific Integrated Circuit) 802, a non-volatile storage device and a volatile storage device. The processor 81 performs various processes in the image forming apparatus 100 and performs various functions by executing a program which is introduced in advance in the memory 82. The memory 82 is configured by a FROM (Flash Read Only Memory), an SRAM (Static Random Access Memory), a DRAM (Dynamic Random Access Memory), a VRAM (Video RAM), a hard disk drive, or the like. Further, the memory 82 stores various types of information and programs that are used in the image forming apparatus 100.

The image forming apparatus 100 has a control panel 810. The control panel 810 receives an instruction from a user and displays a processing content performed to the user and an operation method of the image forming apparatus 100.

Further, the image forming apparatus 100 includes a temperature sensor 30 for measuring the temperature in the apparatus and a humidity sensor 31 for measuring the humidity in the apparatus.

Subsequently, the charging roller and the photoconductive drum in the first embodiment will be described. The following description will be made about the process unit 1a, and the charging roller 5a and the photoconductive drum 3a will be described, however, the other charging rollers 5b, 5c and 5d, and the photoconductive drums 3b, 3c and 3d have the same configuration.

The charging roller 5a is an injection molded charging roller, and the surface thereof is formed by kneading an ion conduction agent into a polypropylene resin, and it is possible to charge an area in which a distance (gap) from a surface of the photoconductive drum 3a is from 50 μm or more to approximately 300 μm.

In the related art, it was not easy to charge if the gap was out of a range of 10 μm to 50 μm, however, owing to recent improvements in the charging roller, a roller which is chargeable even with a large gap was developed. It is possible to suppress contamination of the charging roller by widening the gap, and particularly, even if a carrier is mixed in (attached to a surface of the photoconductive drum), it is possible to pass through due to the large gap. Accordingly, it is possible to suppress deterioration of the surface of the photoconductive drum, such as holes or scratches.

In such a charging method, in which a gap is provided between the photoconductive drum and the charging roller, a DC voltage or a voltage in which an AC voltage is overlapped with the DC voltage, is applied to a shaft (cored bar) of the charging roller, thereby proximity discharge is generated in the gap between the photoconductive drum and the charging roller, and the photoconductive drum is charged. In the present embodiment, as described above, a bias in which −600 V DC is overlapped with 2 kVpp (1 kHz), is applied.

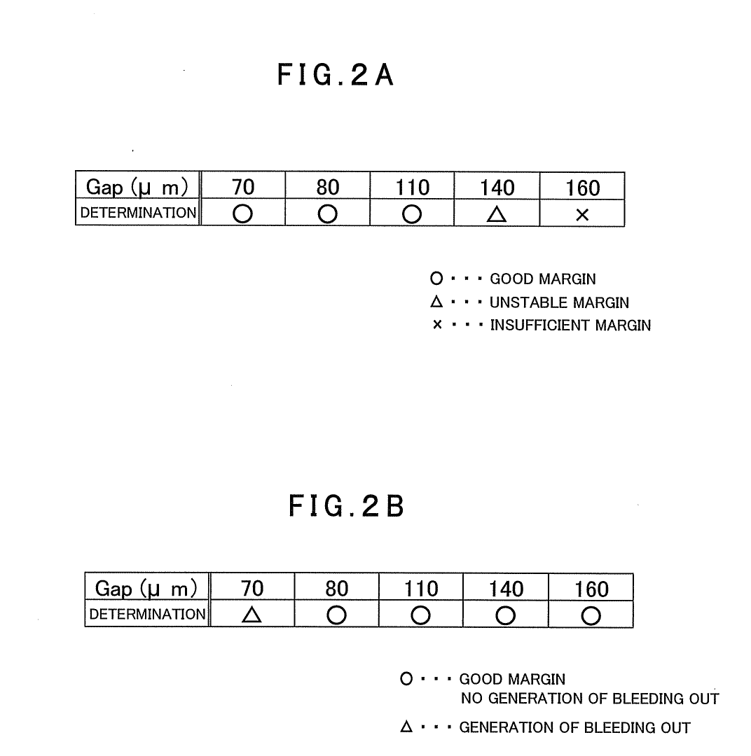

Subsequently, the environmental properties of the charging roller 5a will be described in detail. In FIG. 2A, a relationship is illustrated between a margin determination result and the gap in a low temperature and low humidity environment in which, as an example, the temperature in the apparatus is 10° C. and the humidity is 20%. In FIG. 2B, a determination result is illustrated in a high temperature and high humidity environment in which, as an example, the temperature in the apparatus is 30° C. and the humidity is 85%. In the low temperature and low humidity environment shown in FIG. 2A, it is not easy to discharge due to an increase in the resistance of the roller, so that the gap margin (a range of a gap condition where a uniform discharge is possible) is narrowed. In the example of FIG. 2A, the resistance value increases up to 3×10⁸ Ωcm, and the dischargeable gap is narrowed to about 140 μm.

Meanwhile, as shown in FIG. 2B, in the high temperature and high humidity environment, the margin is good, even if the gap is 140 μm or more, however, in a case of 70 μm, bleeding out occurs. In this manner, due to a problem of bleeding out of the conduction agent or the like, it is desired to maintain the gap to be larger than 70 μm. In FIGS. 2A and 2B, the optimal gap in any temperature and humidity environment is in a range of 70 μm to 140 μm.

Here, for example, in the high temperature and high humidity environment, the image forming apparatus is set to have a gap of 110 μm between the photoconductive drum and the charging roller. When the image forming apparatus is moved and provided in the low temperature and low humidity environment, since the charging roller contracts due to the properties of the material, the gap increases by the amount of contraction. At this time, if the gap exceeds 140 μm, uniform charging is not performed.

In contrast, if the image forming apparatus is set and operated in the high temperature and high humidity environment, the charging roller expands and the gap is narrowed. If the gap is narrowed to 70 μm or less, contamination of the photoconductor occurs due to bleeding out (oozing out).

In this manner, in order to prevent inconvenience due to fluctuation of the gap, it is necessary to adjust the gap according to the environment.

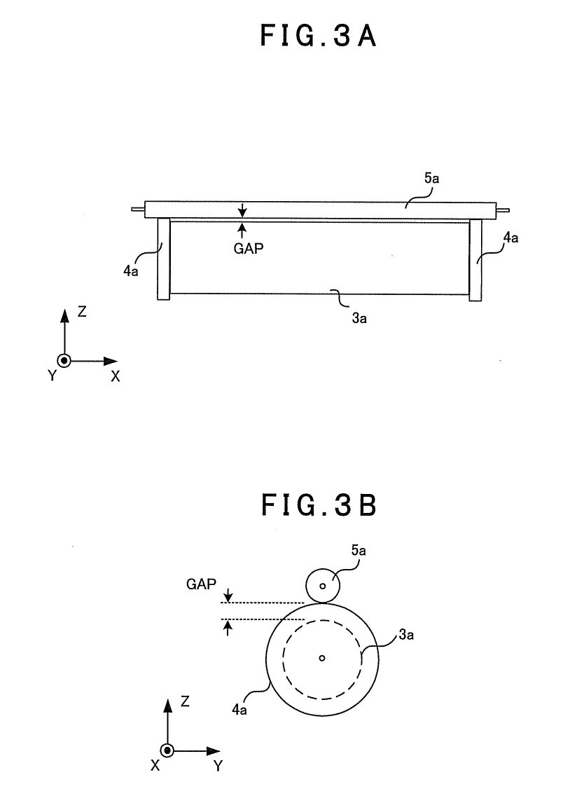

FIGS. 3A and 3B show examples of arrangement of the charging roller 5a, the photoconductive drum 3a, and a positioning member (positioning portion) of the first embodiment. FIGS. 3A and 3B show the charging roller 5a on the upper side and the photoconductive drum 3a on the lower side. In addition, in the drawings, the direction of rotation axis of the charging roller 5a and the photoconductive drum 3a is a horizontal direction. As shown in the front view of FIG. 3A and the side view of FIG. 3B, the charging roller 5a and the photoconductive drum 3a have a cylindrical shape, respectively, and rotate on an axis which is a line joining the center of the two circular planes of the cylindrical shape, respectively.

In the first embodiment, as shown FIGS. 3A and 3B, the positioning member 4a is provided. That is, it has a configuration in which the positioning member 4a having a cylindrical shape, is fixed to both ends in the rotation axis direction (the X axis direction) of the photoconductive drum 3a and a circumferential face of the positioning member 4a comes into close contact with both end surfaces of the charging roller 5a. The positioning member 4a rotates with the same axis as the rotation axis of the photoconductive drum 3a. In addition, in order to form a gap, the diameter of the positioning member 4a is larger than that of the photoconductive drum 3a.

It is possible to automatically adjust the gap according to the temperature and humidity, using a material which contracts in a low temperature and low humidity environment and expands in a high temperature and high humidity environment in the positioning member 4a. When adopting such a material, the positioning member 4a contracts in the low temperature and low humidity environment so as to narrow the gap between the charging roller 5a and the photoconductive drum 3a, and the positioning member 4a expands in the high temperature and high humidity environment so as to widen the gap.

More preferably, by adopting a material having a coefficient of expansion of 100×10⁻⁶/K or more in the positioning member 4a, it is possible to adjust the gap on the order of several tens of μm. More specifically, as the resin materials, there are silicon resin (coefficient of expansion of 250×10⁻⁶/K), polyethylene resin (coefficient of expansion of 130×10⁻⁶/K), or shock resistant-grade ABS resin (coefficient of expansion of 130×10⁻⁶/K). In addition, for the ABS resin, there is synthetic resin constituted by acrylonitrile, butadiene, and styrene.

In addition, the expansion and contraction of the charging roller 5a due to the environmental fluctuation is uniformly performed for the entire charging roller 5a. In other words, even if the charging roller 5a expands and contracts, the charging roller maintains a uniform outer circumferential face, since there is no difference between the sizes of the diameter of the cylinder in the contacting place with the positioning member 4a and the diameter of cylinder in the center portion thereof. In this manner, in a configuration of the first embodiment, even if the charging roller 5a expands or contracts, there is no influence on the variation of gap. The gap fluctuates only by the expansion and contraction of the positioning member 4a. Accordingly, in the first embodiment, the coefficient of expansion of a material used for the charging roller 5a is not specifically required.

### Second embodiment

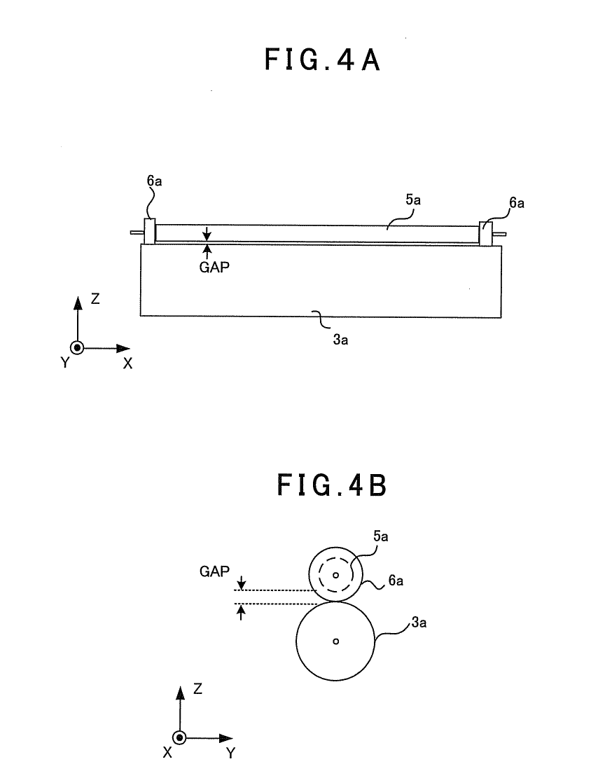

FIG. 4A (front view) and FIG. 4B (side view) show an example of arranging a charging roller 5a, a photoconductive drum 3a, and a positioning member in a second embodiment. In addition, it has the same configuration as that of the first embodiment except for the descriptions which will be made hereinafter.

In the second embodiment, it has a configuration in which the positioning member 6a which has a larger cylindrical diameter than that of the charging roller 5a, is disposed on the charging roller 5a side, and the surface of the positioning member 6a (side wall face of the cylinder) comes into close contact with the surface of the photoconductive drum 3a (a side wall face of the cylinder). The positioning member 6a is fixed to both ends in the rotation axis direction (an X axis direction) of the charging roller 5a and rotates on the same axis as the rotation axis of the charging roller 5a. The positioning member 6a has a cylindrical shape with a larger diameter than that of the charging roller 5a and the cylindrical outer circumferential surface thereof comes into close contact with the surface of the photoconductive drum 3a.

Similarly to the deformation of the positioning member 6a due to a variation in temperature and humidity, the outer shape of the charging roller 5a deforms according to the changes of temperature and humidity. For the reason, that the fluctuation in diameter of the charging roller 5a is smaller than that of the positioning member 6a, in order for the gap to narrow in a low temperature and low humidity environment, and the gap to expand in a high temperature and high humidity environment, becomes a condition. In other words, it is necessary to make the coefficient of expansion of the positioning member 6a be larger than the coefficient of expansion of a material used on the surface of the charging roller 5a.

For example, when the fluctuation in diameter of the charging roller 5a is larger than that of the positioning member 6a, in the low temperature and low humidity environment, the positioning member 6a contracts to narrow the gap; however, the contraction of the charging roller 5a become large. As a result, conversely, the gap becomes large. Meanwhile, in the high temperature and high humidity environment, the positioning member 6a expands to widen the gap; however, a diameter of the charging roller 5a expands to be large. As a result, conversely, the gap narrows.

In this manner, if not set as a configuration with an optimal configuration using materials having an optimal coefficient of expansion, advantage of changing the gap in the reverse direction may not be obtained.

As a specific example of the embodiment, when ABS resin (coefficient of expansion of 74×10⁻⁶/K) is adopted as the material of the charging roller 5a, polypropylene (coefficient of expansion of 110×10⁻⁶/K) or POM (polyacetal) (coefficient of expansion of 90×10⁻⁶/K) is adopted as the material of the positioning member 6a.

### Third embodiment

In a third embodiment, a configuration example of mechanically controlling a fluctuation of a gap will be described. In addition, in the following description, the explanation is made without considering the expansion and contraction of each member; however, an implementation in which the contraction and expansion of the members are considered may also be possible. Further, it has the same configuration as that of the first embodiment except for the following descriptions.

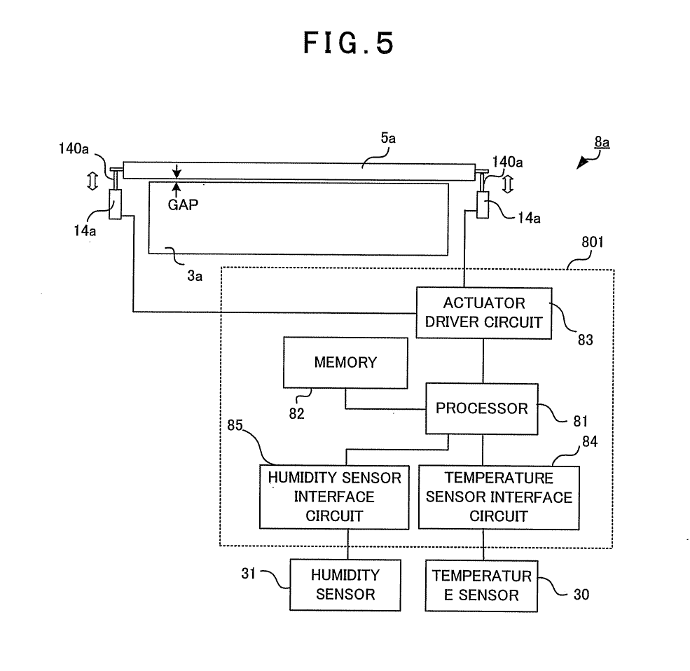

FIG. 5 shows a configuration example of the third embodiment. In the configuration of the third embodiment, the gap is adjusted using an actuator 14a. The actuator 14a includes a support pin 140a and the support pin 140a is moved in the vertical direction (the vertical direction in FIG. 5). The support pin 140a supports the rotation axis of a charging roller 5a and the charging roller 5a is moved vertically (the direction in which the charging roller 5a faces a photoconductive drum 3a) together with the vertical movement of the support pin 140a. In the embodiment, a general purpose actuator, such as an electric direct drive-type motor, is used as the actuator 14a.

A driving control of the actuator 14a is performed using a control board 801. The control board 801 obtains values detected from a temperature sensor 30 and a humidity sensor 31 and controls the actuator 14a by converting the obtained values to a temperature value (° C.) and humidity value (%).

A configuration of the inside of the control board 801 will be described. As described above, the control board 801 has a processor 81, a memory 82, and further has an actuator driver circuit 83, a temperature sensor interface circuit 84, and a humidity sensor interface circuit 85.

The actuator driver circuit 83 controls the actuator 14a to cause a current flow which is corresponding to an output level determined by the processor 81.

The temperature sensor interface circuit 84 transmits a signal of the start and stop of detection which is transmitted from the processor 81 to the temperature sensor 30, and transmits each signal value from the temperature sensor 30 to the processor 81.

The humidity sensor interface circuit 85 transmits a signal of start and stop of detection which is transmitted from the processor 81, to the humidity sensor 31, and transmits each signal value from the humidity sensor 31 to the processor 81. The actuator driver circuit 83, the temperature sensor interface circuit 84, and the humidity sensor interface circuit 85 are mounted using an ASIC 802.

The memory 82 stores a table which derives an output level from the temperature value and the humidity value. The processor 81 calculates and executes a program stored in advance in the memory 82 and outputs a control signal or the like, to the actuator driver circuit 83, the temperature sensor interface circuit 84, and the humidity sensor interface circuit 85.

A positioning member 8a includes the control board 801, the temperature sensor 30, the humidity sensor 31, and the actuator 14a. In addition, with respect to charging rollers 5b to 5d and photoconductive drums 3b to 3d, corresponding positioning portions 8b to 8d which have the same configuration as that of the positioning portion 8a are provided.

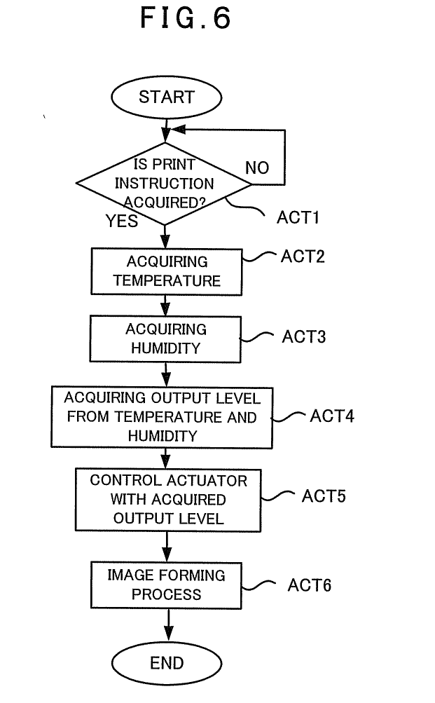

An operation example of each unit will be described referring to a flowchart in FIG. 6.

First, an instruction of starting the execution will be obtained when the processor 81 detects pressing down of a start button for copying on a control panel 810 (Act 1). In Act 1, the instruction of starting the execution of a printing job may be obtained from an external device. When the start instruction is obtained (ACT 1, Yes), the processor 81 obtains a temperature value from the temperature sensor 30 through the temperature sensor interface circuit 84 and temporarily stores the value in the memory 82 (ACT 2). The same job is applied to humidity. The processor 81 obtains a humidity value from the humidity sensor 31 through the humidity sensor interface circuit 85 and temporarily stores the value in the memory 82 (ACT 3).

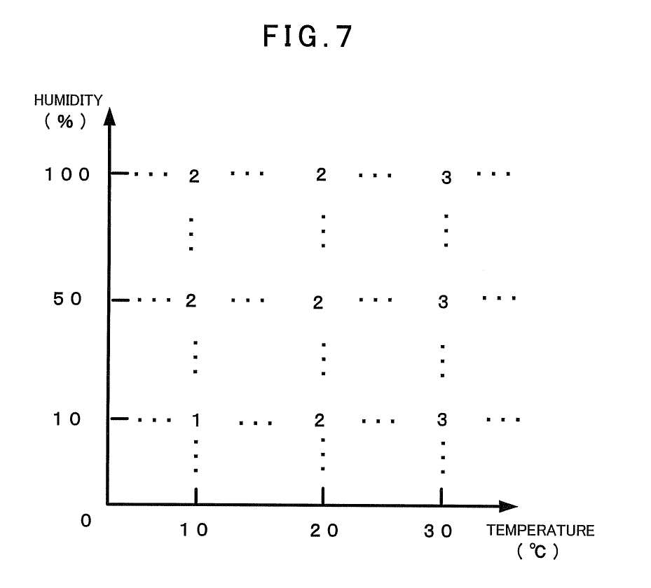

Subsequently, the processor 81 derives an output level which is output to the actuator driver circuit 83 on the basis of the obtained temperature value and humidity value using the table stored in the memory 82 (ACT 4). The method of obtaining the output level from the temperature value and humidity value will be described while referring to FIG. 7. In the example, the output level is set to 1 to 3. The level 1 has a small gap and the gap increases as the level becomes higher.

In the example in FIG. 7, when the temperature is 10° C. or less and the humidity is 10% or less, the output level is set to 1, and when the temperature is more than 10° C. and less than 30° C., and the humidity is more than 10% and 100% or less, the output level is set to 2. In addition, when the temperature is 30° C. or more, the output level is set to 3. Further, each value or number of level shown in FIG. 7 is only an example and does not define the embodiment.

A table in which a corresponding relationship which is described using FIG. 7, that is, the temperature value, the humidity value and the output level are correlated with each other, is stored in the memory 82. The processor 81 retrieves the table on the basis of the temperature value and humidity value that are obtained from each sensor, to obtain the output level.

Subsequently, the processor 81 outputs the control start signal and the obtained output level to the actuator driver circuit 83. The actuator driver circuit 83 controls a current value of the actuator 14a in a voltage level corresponding to the obtained output level, and the actuator 14a moves the pin 140a in the vertical direction so that the pin is positioned to correspond to the current value (ACT 5).

Accordingly, the charging roller 5a and the photoconductive drum 3a approach to or separate from each other.

After the fluctuation of the gap, an image is formed on a sheet (ACT 6).

In addition, a configuration is possible in which a user is notified and the gap is adjusted by the user. Hereinafter, a configuration example of this case will be described.

First, the processor 81 obtains measurement values of the temperature sensor 30 and the humidity sensor 31, respectively. Next, the processor 81 displays an operation method in which the gap has a length that is based on the obtained respective measurement values (gap length in which a margin of the charging roller 5a is secured and bleeding out does not occur), on the control panel 810. The control panel 810 displays an image of the image forming apparatus 100 which is near the inside of the apparatus, and displays text information such as “Please rotate the nozzle B twice to the right.” as the operation method, for example.

As the third embodiment, the pin supporting the charging roller is moved, based on the detection result of the temperature sensor and the humidity sensor, using the actuator, thereby it is possible to more precisely control the gap than in the first and second embodiments.

However, in the first and second embodiments, sensors and components such as the actuator are not necessary, so the gap can be automatically adjusted at a low cost and with simple configuration.

As described above, according to the embodiments written in the specification, it is possible to automatically change and adjust a gap due to environmental changes, and to obtain a stable charging performance.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a photoconductor;
a charging unit which charges the photoconductor, and is disposed to face the photoconductor in a non-contact manner; and
a positioning portion which changes a gap interposed between the photoconductor and the charging unit based on at least a temperature.

2. The apparatus according to claim 1,
wherein, if the gap is set to a first length in a case of a predetermined temperature, the positioning portion changes the gap so as to be longer than the first length when the temperature is higher than the predetermined temperature.

3. The apparatus according to claim 1,
wherein, if the gap is set to the first length in a case of the predetermined temperature and the predetermined humidity, the positioning portion changes the gap so as to be longer than the first length when the temperature and the humidity are higher than the predetermined temperature and the predetermined humidity.

4. The apparatus according to claim 1,
wherein, the positioning portion changes the gap by expanding or contracting corresponding to the temperature.

5. The apparatus according to claim 1,
wherein, the photoconductor has a cylindrical shape and rotates having, as an axis, a line which joins a center point of two circular planes of the cylindrical shape, and
wherein, the positioning portion is disposed at both end of the photoconductor in the rotation axis direction, rotates on the same axis as the rotation axis, has a cylindrical shape with a larger diameter than that of the photoconductor, and in the positioning portion, an outer circumferential surface of the cylindrical shape comes into close contact with a surface of the charging unit.

6. The apparatus according to claim 5,
wherein, the coefficient of expansion of a material of the positioning portion is 100×10⁻⁶/K or more.

7. The apparatus according to claim 6,
wherein, the positioning portion is formed of any one of materials of silicon resin, polyethylene resin, and ABS resin.

8. The apparatus according to claim 1,
wherein, the charging unit has a cylindrical shape and rotates having, as an axis, a line which joins a center point of two circular planes of the cylindrical shape, as an axis, and
wherein, the positioning portion is disposed at both ends of the charging unit in the rotation axis direction, rotates in the same axis as the rotation axis, has a cylindrical shape with a larger diameter than that of the charging unit, an outer circumferential surface of the cylindrical shape thereof comes into close contact with a surface of the photoconductor.

9. The apparatus according to claim 8,
wherein, the coefficient of expansion of a material of the positioning portion is larger than that of a material used on a surface of the charging unit.

10. The apparatus according to claim 1,
wherein, the positioning portion includes:
a temperature sensor for measuring the temperature;
an actuator which holds the charging unit and moves the charging unit in a direction where the charging unit and the photoconductor face each other; and
a control portion which obtains a measurement value of the temperature sensor and controls a driving amount of the actuator on the basis of the measurement value of the temperature sensor.

11. The apparatus according to claim 10,
wherein, the positioning portion further includes a humidity sensor for measuring a humidity, and
wherein, the control portion obtains a measurement value of the humidity sensor and controls a driving amount of the actuator on the basis of the measurement values of the temperature sensor and the humidity sensor.

12. The apparatus according to claim 11,
wherein, the control portion includes a storage portion for storing a table in which a temperature value, a humidity value and an output level to the actuator are correlated to each other,
wherein, the table is retrieved on the basis of the measurement value of the temperature sensor and the measurement value of the humidity sensor to obtain the corresponding output level and to output the output level to the actuator, and
wherein, the actuator inputs the output level and moves the charging unit according to the level.

13. An image forming apparatus comprising:
a display unit;
a temperature sensor for measuring a temperature;
a humidity sensor for measuring humidity;
a photoconductor;
a charging unit which charges the photoconductor and is disposed to face the photoconductor in a non-contact manner;
and
a control portion in which measurement values of the temperature sensor and the humidity sensor are obtained respectively, and an operation method is displayed on the display unit such that a gap length is set as a length between the photoconductor and the charging unit, and as a length in which a margin of the charging unit is secured and bleeding out does not occur, on the basis of the obtained respective measurement values.

14. A gap control method,
wherein, an image forming apparatus including a photoconductor and a charging unit which charges the photoconductor, and is disposed to face the photoconductor in a non-contact manner, changes a gap interposed between the photoconductor and the charging unit, based on at least a temperature.

15. The method according to claim 14,
wherein the image forming apparatus includes a positioning portion which comes into close contact with the photoconductor and the charging unit, and changes the gap when the positioning portion expands or contracts, corresponding to the temperature.

16. The method according to claim 15,
wherein, when the positioning portion is fixed to the photoconductor and the surface of the positioning portion and the surface of the charging unit are coming into close contact with each other, a material having a coefficient of expansion of 100×10⁻⁶/K or more is used in the positioning portion.

17. The method according to claim 15,
wherein, when the positioning portion is fixed to the charging unit and the surface of the positioning portion and the surface of the photoconductor are coming into close contact with each other, a material having a larger coefficient of expansion than that of a material used on the surface of the charging unit, is used in the positioning portion.

18. The method according to claim 14,
wherein, the image forming apparatus measures a temperature inside the image forming apparatus, and
wherein, a driving amount of the actuator which holds the charging unit and moves the charging unit to a direction where the charging unit and the photoconductor face each other, is controlled on the basis of the measured temperature, to thereby change the gap.

19. The method according to claim 18,
wherein, the image forming apparatus further measures a humidity inside the image forming apparatus and controls the driving amount of the actuator on the basis of the measured temperature and the measured humidity.

20. The method according to claim 19,
wherein, the image forming apparatus stores a table in advance, in which a temperature value, a humidity value and an output level to the actuator are corresponding to one another, and
wherein, the table is retrieved on the basis of the measurement values of the temperature and humidity, to obtain the corresponding output level, and the driving amount of the actuator is controlled by outputting the output level to the actuator.
